(19) United States
(12) Patent Application Publication
(10) Pub. No.: US 2003/0226922 A1
(43) Pub. Date: Dec. 11, 2003

(54) Method of alluviating rock and sand

(76) Inventor: Joe Scates, Chewelah, WA (US)

Correspondence Address: JENSEN + PUNTIGAM, P.S., SUITE 1020, 2033 6TH AVE, SEATTLE, WA, 98121, US

(21) Appl. No.: 10/167,177

(22) Filed: Jun. 11, 2002

(51) Int. Cl. B02C 19/12

(52) U.S. Cl. 241/275

(57) ABSTRACT

A method of alluviating rock and sand, including the control of the rate and speed of impact to generate a smooth product. The product may be treated more than once to achieve the desired result.

### TECHNICAL FIELD

This invention relates to the field of alluviating rock, and more particularly, to the repetitive contact of particles of rock or sand, as they are being ushered through a processing machine, wherein the speed of the machine, the frequency of impact and the duration of impact are all under the control of the operator. The rock may be recycled if necessary to achieve the desired result. In this application the term “rock” also applies to “sand”.

### BACKGROUND OF THE INVENTION

It has been found desirable in some applications to have sand or small rock having a smooth surface. This occurs when rock or sand is constantly agitated, as in a river bed or alluviated mechanically. It has been found difficult to replicate the river environment and virtually impossible to remove material from the rivers.

The smooth surface is desirable when the material is to form a surface or part of a surface that will be in contact with a live body such as the surface of swimming pools, decking or other decorative surfaces.

Although it is well known to mechanically crush rock as illustrated by the references cited herein, these known machines yield a product that has sharp edges and is therefore not suitable for surfaces designed for human contact. To remove the sharp edges, the small stones or sand particles must respectively contact each other with enough impact to remove the edges without shattering or creating an abundance of dust. It is imperative that the rate of flow of the material, the number and strength of impact and the number of cycles be controlled to assure a uniform product.

U.S. Pat. No. 4,436,138, granted to Kondo Mar. 13, 1984, discloses an apparatus and method for reclaiming used molding sand, and wherein one of the principal concerns is driving off the dust.

U.S. Pat. No. 4,662,571, granted to McDonald et al, May 5, 1987, discloses an apparatus for breaking minerals.

U.S. Pat. No. 5,618,223, granted to Masuno et al, Apr. 8, 1997, discloses a method of removing material adhering to used sand by means of an abrasive contact.

U.S. Pat. No. 5,706,879, granted to Renner et al, Jan. 13, 1998, discloses an apparatus for reclamation of used foundry sand, utilizing abrasive contact between particles to drive off the binder particles that have adhered to the sand.

U.S. Pat. No. 5,860,605, granted to Van Der Zanden, Jan. 19, 1999, discloses apparatus wherein the speed, angle and impact can be predetermined for treating granular products.

U.S. Pat. No. 5,863,004, granted to Broillet, Jan. 26, 1999, discloses a structure for a granulating machine.

U.S. Pat. No. 5,921,484, granted to Smith et al, Jul. 14, 1999, discloses an impeller for a rock crushing machine.

U.S. Pat. No. 6,032,889, granted to Thrasher on Mar. 7, 2000, discloses a rock crushing machine.

### SUMMARY OF THE INVENTION

With the above-noted prior art in mind, it is an object of the present invention to provide a method of removing the rough surfaces of rock or sand.

It is another object of the present invention to provide a method for removing the rough edges of small rock or sand by repetitive controlled contact with identical elements.

It is yet another object of the present invention to provide a method of alluviating rock, wherein the strength and degree of impact can be controlled.

### BRIEF DESCRIPTION OF THE DRAWINGS

FIG. 1 is a side elevational view, partially in section, depicting machinery utilized in performing the inventive method.

### BEST MODE FOR CARRYING OUT THE INVENTION

The sand or small rock to be alluviated is stored in storage tanks, not shown, and fed to the mechanism via a plurality of hoses, preferably three six (6) inch hoses, 2,4,6, which feed directly into a distribution tank 8, wherein each of the hoses 2,4,6 have a pneumatically operated gate 10 at their lower end to control the rate of the flow.

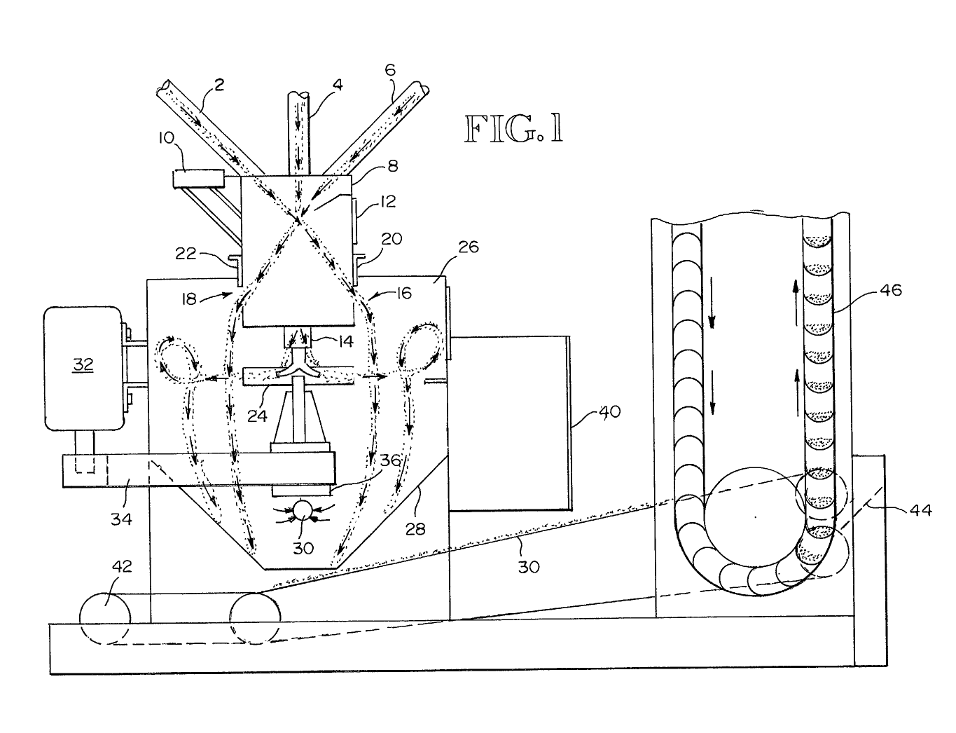

Tank 8 likewise includes an inspection door 12. The sand or small rock leaves the tank 8 via a central opening 14, but in the alternative, the material will flow outwardly of the tank 8 to gated openings 16, 18, controlled by the gates 20, 22. The product that flows through the bottom central opening 14 encounters a rotating cylindrical platform 24 wherein is impelled radially outwardly therefrom forming a fluid bed which intersects the material coming from the opening 16, 18. the resulting soft collision causes the material to have individual multiple collisions before encountering the exterior wall of the containment vessel 26 and flowing downwardly thereof to contact the tapered upper portion 28 to be funneled onto a moving belt 30. Also to be seen in this portion of FIG. 1 is a variable speed driving motor 32 which drives a belt 34, connected to a pulley 36, which causes a rotation of the platform 24. Also seen in this view is a dust removal vent 38, through which dust is removed and subsequently treated. Along the side of the main containment vessel 26 is a catwalk 40.

The moving belt 30 driven by a motor 42 carries the material upwardly to a position where it falls of the belt 30 and encounters a screen element 44, determining the size of the particles passing therethrough. The particles that do not pass through screen 44 move down the screen to encounter a multiple bucket conveyor 46, which carries those particles back up to the original storage bin for recirculation through the process.

Alternatively, the operator may direct the particles directly to conveyor 46 to repeat the cycle.

1) A method of alluviating rock, comprising the steps of:
placing the rock in one or more storage containers;
moving the rock to a main supply bin;
feeding a portion of rock to a rotating member, which causes the rock to spiral outwardly, forming a fluid bed;
feeding a portion of the rock outwardly from the main supply bin such that when it falls it intersects the fluid bed causing rock-to-rock contact, smoothing the corners without shattering the rocks;
screening the rock; and
recirculating the rock as necessary to achieve the desire product.

2) A method as in claim 1, wherein the portion of rock fed outwardly passes through adjustable gates to control the flow and agitation.

3 A method as in claim 1 and further including the step of removing dust.
